(19) United States
(12) Patent Application Publication
(10) Pub. No.: US 2023/0376754 A1
(43) Pub. Date: Nov. 23, 2023

(54) PARALLEL MACHINE LEARNING METHOD AND INFORMATION PROCESSING APPARATUS

(71) Applicant: Fujitsu Limited, Kawasaki-shi (JP)

(72) Inventors: Maryna Baida, Kawasaki (JP); HIROKI OHTSUJI, Yokohama (JP)

(73) Assignee: Fujitsu Limited, Kawasaki-shi (JP)

(21) Appl. No.: 18/160,318

(22) Filed: Jan. 27, 2023

(30) Foreign Application Priority Data
May 17, 2022 (JP) 2022-080723

(51) Int. Cl. G06N 3/08

(52) U.S. Cl. CPC G06N 3/08

(57) ABSTRACT

A computer measures, in a first iteration among a plurality of iterations performed in synchronization with a different computer, each of the plurality of iterations including a training process for reading out training data from a buffer area and updating a parameter value of a machine learning model and a prefetch process for requesting a storage apparatus shared with the different computer to send training data such that the training data stored in the buffer area reaches a certain data amount, a first readout time in which the training data is read out from the buffer area. The computer increases the certain data amount used in a second iteration performed after the first iteration if first delay conditions including a condition that the first readout time is greater than a second readout time measured by the different computer in the first iteration are satisfied.

### CROSS-REFERENCE TO RELATED APPLICATION

Error! No sequence specified. This application is based upon and claims the benefit of priority of the prior Japanese Patent Application No. 2022-080723, filed on May 17, 2022, the entire contents of which are incorporated herein by reference.

### FIELD

The embodiments relate to a parallel machine learning method and an information processing apparatus.

### BACKGROUND

There is parallel machine learning in which the machine learning time is shortened by causing a plurality of information processing apparatuses to train the same machine learning model in a coordinated way. In this parallel machine learning, the plurality of information processing apparatuses generate fragmentary information for updating parameter values of the machine learning model in parallel from different training data. The plurality of information processing apparatuses aggregate these items of fragmentary information and update the parameter values. Normally, the plurality of information processing apparatuses acquire the same updated parameter values. The plurality of information processing apparatuses repeat this parameter value update iteration in synchronization with each other.

For example, each of the plurality of information processing apparatuses calculates the error of the output of a neural network from a certain amount of training data referred to as a mini batch and calculates the error gradient of the individual parameter value by performing a backpropagation method. The plurality of information processing apparatuses aggregate the error gradients calculated from the different training data and update the parameter values by using the aggregated error gradient. The plurality of information processing apparatuses repeat the above iteration while changing the training data.

There has been proposed a cache optimization method. Specifically, when parallel machine learning for training a neural network by using a plurality of compute nodes is performed, a cache memory line conflict is detected, and the line conflict is resolved by changing a cache way.

See, for example, U.S. Patent Application Publication No. 2021/0349835.

### SUMMARY

In one aspect, there is provided a non-transitory computer-readable recording medium storing therein a computer program that causes a computer to execute a process including: measuring, in a first iteration among a plurality of iterations performed in synchronization with a different computer, each of the plurality of iterations including a training process for reading out training data from a buffer area and updating a parameter value of a machine learning model and a prefetch process for requesting a storage apparatus shared with the different computer to send training data such that the training data stored in the buffer area reaches a certain data amount, a first readout time in which the training data is read out from the buffer area; and increasing the certain data amount used in a second iteration performed after the first iteration responsive to first delay conditions including a condition that the first readout time is greater than a second readout time measured by the different computer in the first iteration being satisfied.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an example of an information processing system according to a second embodiment;

FIG. 3 is a block diagram illustrating a hardware example of a computation node;

FIG. 4 illustrates a configuration example of a neural network;

FIG. 5 illustrates an example of parallel machine learning performed by a plurality of computation nodes;

FIG. 6 illustrates an example of training data stored in a storage server;

FIG. 7 illustrates an example of a temporary delay in a storage prefetch;

FIG. 8 illustrates an example of deterioration in the throughput of the storage server;

FIG. 9 illustrates the first half of an example in which buffer sizes are changed;

FIG. 10 illustrates the second half of the example in which the buffer sizes are changed;

FIG. 11 is a block diagram illustrating an example of a software hierarchy of the computation node;

FIG. 12 is a block diagram illustrating a functional example of the computation node;

FIG. 13 is a flowchart illustrating an example of a machine learning procedure;

FIG. 14 is the first half of a flowchart illustrating an example of an iteration execution procedure; and

FIG. 15 is the second half of the flowchart illustrating the example of the iteration execution procedure.

### DESCRIPTION OF EMBODIMENTS

Training data used by a plurality of information processing apparatuses may be stored in a shared storage apparatus. The plurality of information processing apparatuses may read out the training data from the storage apparatus as needed while performing iterations. In this case, the reading out of training data from the storage apparatus to one information processing apparatus could be temporarily delayed by an accidental cause, e.g., by a collision of requests from two or more information processing apparatuses. If a latency in receiving training data occurs in one information processing apparatus and the start of an iteration is delayed, because the other information processing apparatuses need to perform the iteration in synchronization with each other, the other information processing apparatuses could also be affected. That is, a latency could also occur in the other information processing apparatuses.

One possible solution to this problem is that each of the plurality of information processing apparatuses performs a prefetch process in which each information processing apparatus requests the storage apparatus to send training data used in a certain iteration before the certain iteration. The training data received by the prefetch process is stored in a buffer area. However, if the data amount of the buffer area is fixed and if an inappropriate data amount is set, a delay could occur in prefetching the training data, and a latency could consequently occur.

For example, if the data amount of a buffer area is excessively small, there is a case in which the buffering may fail to cover a temporary prefetch delay. That is, at the start of an iteration, the training data used in the iteration could not be sufficiently stored in the buffer area. In contrast, if the data amount of a buffer area is excessively large, there is a case in which the plurality of information processing apparatuses may attempt to prefetch a large amount of training data at the same time. As a result, the load on the storage apparatus is increased and the throughput thereof is deteriorated. Thus, a prefetch delay could occur in all the plurality of information processing apparatuses.

Hereinafter, the embodiments will be described with reference to drawings.

### First Embodiment

A first embodiment will be described.

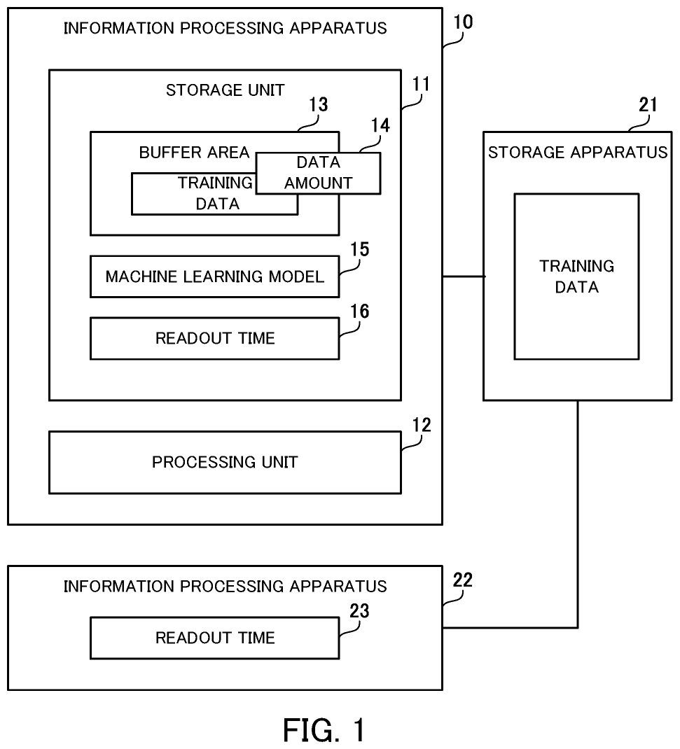

FIG. 1 illustrates an information processing apparatus according to the first embodiment.

This information processing apparatus 10 according to the first embodiment performs parallel machine learning in coordination with other information processing apparatuses such as an information processing apparatus 22. The information processing apparatuses 10 and 22 repeat an iteration for updating parameter values included in a machine learning model 15 in synchronization with each other. The information processing apparatuses 10 and 22 may each be a client apparatus or a server apparatus. The information processing apparatuses 10 and 22 may each be referred to as a computer, a node, or a machine learning apparatus.

The information processing apparatus 10 includes a storage unit 11 and a processing unit 12. The storage unit 11 may be a volatile semiconductor memory such as a random access memory (RAM) or a nonvolatile storage such as a hard disk drive (HDD) or a flash memory. The processing unit 12 is, for example, a processor such as a central processing unit (CPU), a graphics processing unit (GPU), or a digital signal processor (DSP). The processing unit 12 may include an electronic circuit such as an application specific integrated circuit (ASIC) or a field programmable gate array (FPGA). The processor executes a program stored in a memory such as a RAM (such as the storage unit 11), for example. A group of processors may be referred to as a multiprocessor or simply a “processor”.

The storage unit 11 includes a buffer area 13. The buffer area 13 stores training data received from a storage apparatus 21. The storage apparatus 21 stores the training data used by the information processing apparatuses 10 and 22 for machine learning and is accessed by both of the information processing apparatuses 10 and 22. The storage apparatus 21 stores the training data in a nonvolatile storage device such as an HDD or a flash memory. The storage apparatus 21 may be a server apparatus. The storage apparatus 21 reads out and transmits training data in response to requests from the information processing apparatuses 10 and 22.

The information processing apparatuses 10 and 22 and the storage apparatus 21 may communicate with each other via a network such as a local area network (LAN). For example, the information processing apparatuses 10 and 22 and the storage apparatus 21 are connected to a network switch. The training data includes a plurality of records, in each of which input data that is inputted to the machine learning model 15 and correct data indicating a correct answer of the output of the machine learning model 15 are associated with each other. If the machine learning model 15 is an image recognition model, for example, the input data includes image data, and the correct data includes correct classes. The machine learning model 15 includes at least one parameter value. The machine learning model 15 may be a neural network and may include parameter values indicating edge weights.

The processing unit 12 performs a plurality of iterations in synchronization with the information processing apparatus 22. The transition timing from one iteration to the next iteration is synchronized between the information processing apparatuses 10 and 22. Thus, even when the information processing apparatus 10 completes a certain process in one iteration, there are cases in which the information processing apparatus 10 does not proceed to the next iteration but waits until the information processing apparatus 22 completes the certain process. The individual iteration includes a training process and a prefetch process.

In the training process, the individual information processing apparatus reads out a certain amount of training data from its buffer area 13 and updates the parameter values of its machine learning model 15. The certain amount of training data is, for example, a certain number of training data records. The certain amount of training data may be referred to as a batch or a mini batch, and the certain amount may be referred to as a batch size or a mini batch size. The certain amount of training data is, for example, data of a certain number of images, each of which is associated with a class label.

For example, in the training process, input data is inputted to the machine learning model 15, and the error between the output of the machine learning model 15 and the corresponding correct data is calculated. In the training process, an average error in a certain amount of training data is calculated. In the training process, the error gradients with respect to the parameter values are calculated by a backpropagation method. In the training process, the information processing apparatuses 10 and 22 exchange error information indicating their error gradients calculated and calculate a sum or an average of the error gradients. In the training process, each of the information processing apparatuses 10 and 22 multiplies the aggregated error gradient by a learning rate and changes the parameter values by the obtained product.

In the prefetch process, the individual information processing apparatus requests the storage apparatus 21 to send training data such that the training data to be stored in the buffer area 13 reaches a data amount 14. The data amount 14 may be referred to as a prefetch amount or a buffer size. In the prefetch process, the individual information processing apparatus requests the storage apparatus 21 to send training data to be used in a certain iteration performed before the certain iteration. In the prefetch process, the individual information processing apparatus stores the training data received from the storage apparatus 21 in its buffer area 13. For example, in the prefetch process, the information processing apparatus requests the storage apparatus 21 to send only the insufficient amount of training data such that the training data in the buffer area 13 will reach the data amount 14 at the start of the next iteration. The initial value of the data amount 14 is, for example, a mini batch size. In this case, in the prefetch process, the individual information processing apparatus requests the storage apparatus 21 to send the training data to be used in a certain iteration in the previous iteration of the certain iteration. The training process and the prefetch process are performed in parallel.

Ideally, it is preferable that the training data to be used in a certain iteration be sufficiently stored in a buffer area 13 at the start of the certain iteration. However, there may be a case in which the training data to be used in a certain iteration is not sufficiently stored in the buffer area 13 at the start of the certain iteration due to a delay in the prefetch process. In this case, in the training process, the buffer area 13 is continuously monitored until the training data to be used in the certain iteration is stored, and the readout time from the start to the end of the reading out of the training data could be extended. As a result, the execution time of this iteration could be extended.

A delay in the prefetch process may be a temporary delay caused when requests from two or more information processing apparatuses accidentally collide. The temporary delay may be referred to as an unexpected delay or an accidental delay. The temporary delay could be caused by a temporary increase in the load on the storage apparatus 21 or a communication apparatus connected to the storage apparatus 21, for example. The temporary delay may be caused only in one of the two or more information processing apparatuses. Thus, a delay fluctuation, in which the response time from when the information processing apparatus 10 requests the storage apparatus 21 to send training data to when the information processing apparatus 10 receives the training data fluctuates, could be caused. If a delay is caused in the prefetch process of the information processing apparatus 10, because the information processing apparatuses 10 and 22 need to perform the iteration in synchronization with each other, a latency may be caused in the information processing apparatus 22.

Thus, the processing unit 12 dynamically adjusts the data amount 14 so as to reduce the latency. The processing unit 12 measures a readout time 16, which is needed for reading out training data from the buffer area 13 in a first iteration. The readout time 16 is a lapse of time from the start of the reading out of the training data used in the first iteration to the end of the reading out of a certain amount of training data. If the training data in the buffer area 13 does not satisfy the certain amount at the start of the first iteration, the readout time 16 could be extended.

The information processing apparatus 22 also measures a readout time 23, which is needed for reading out training data from the buffer area of the information processing apparatus 22 in the first iteration. If delay conditions including a condition that the readout time 16 is greater than the readout time 23 are satisfied, the processing unit 12 increases the data amount 14 to be used in the prefetch process in a second iteration performed after the first iteration. For example, the processing unit 12 receives the readout time 23 from the information processing apparatus 22 and determines whether the delay conditions including the delay condition about the readout time 16 are satisfied.

The delay condition about the readout time 16 is that the ratio of the readout time 16 with respect to the readout time 23 is greater than a threshold that is greater than 1, for example. The second iteration is, for example, the iteration that is performed immediately after the first iteration. By increasing the data amount 14 in the prefetch process, the risk that the training data in the buffer area 13 is insufficient at the start of an iteration due to a temporary delay is reduced. When the information processing apparatus 10 increases the data amount 14, the information processing apparatus 22 may also increase the data amount of its buffer area. In addition, the information processing apparatus 22 may set the data amount of its buffer area to be the same as the data amount 14 of the information processing apparatus 10.

As described above, the information processing apparatus 10 according to the first embodiment measures the readout time 16 in which training data is read out from the buffer area 13 in the first iteration. If the delay conditions including the condition that the readout time 16 is greater than the readout time 23 measured by the information processing apparatus 22 are satisfied, the information processing apparatus 10 increases the data amount 14 to be used in the second iteration performed after the first iteration.

In this way, the information processing apparatus 10 detects a training data reception delay that is not covered by the current prefetch data amount and adjusts the prefetch data amount such that the detected reception delay is covered. Thus, the latency that is caused due to a training data reception delay in the parallel machine learning is reduced. In addition, the user does not need to specify an appropriate data amount 14. The data amount 14 is automatically adjusted to suit the system requirements such as the number of information processing apparatuses, the total amount of training data, and the hardware performance of the storage apparatus 21.

The delay condition about the readout time may be a condition that the ratio of the readout time 16 with respect to the readout time 23 is greater than a threshold. In this way, the information processing apparatus 10 is able to set a threshold that does not depend on the scale of the readout time 16 or 23 and to apply the adjustment of the data amount 14 to various machine learning tasks. In addition, the increase of the data amount 14 of the information processing apparatus 10 may also be applied to the information processing apparatus 22. Because a temporary delay that occurs in the information processing apparatus 10 may also occur in the information processing apparatus 22, the application of the increase of the data amount 14 to the information processing apparatus 22 consequently achieves reduction in latency.

In addition, the information processing apparatus 10 may measure a first prefetch time in which training data is prefetched from the storage apparatus 21 in the first iteration and is stored in the buffer area 13. If delay conditions including a condition that the first prefetch time is greater than a second prefetch time measured by the information processing apparatus 10 in a third iteration performed before the first iteration are satisfied, the information processing apparatus 10 may decrease the data amount 14. The delay condition about the prefetch time may be a condition that the ratio of the first prefetch time with respect to the second prefetch time is greater than a threshold.

If the prefetch data amounts of the plurality of information processing apparatuses are increased, the plurality of information processing apparatuses may request the storage apparatus 21 to send a large amount of training data at the same time. In this way, because the load on the storage apparatus 21 is increased and the throughput is deteriorated, the response time may be extended. As a result, a delay is caused in the prefetch process of each of the plurality of information processing apparatuses. However, by performing the above process, the information processing apparatus 10 is able to detect the deterioration in the throughput of the storage apparatus 21 and to prevent the prefetch data amount from excessively increasing with respect to the hardware performance of the storage apparatus 21.

### Second Embodiment

Next, a second embodiment will be described.

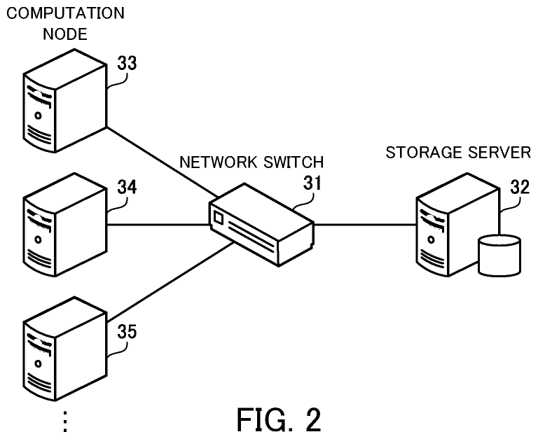

FIG. 2 illustrates an example of an information processing system according to the second embodiment.

The information processing system according to the second embodiment includes a network switch 31, a storage server 32, and a plurality of computation nodes including computation nodes 33 to 35. The number of computation nodes is, for example, 1000. The storage server 32 and the computation nodes 33 to 35 are connected to the network switch 31.

The network switch 31 is a communication apparatus that relays the communication among the storage server 32 and the computation nodes 33 to 35. The network connecting the storage server 32 and the computation nodes 33 to 35 may include a plurality of network switches or include a different kind of communication apparatus such as a router.

The storage server 32 is a server computer that stores training data used in machine learning. The storage server 32 stores the training data in a nonvolatile storage device such as an HDD or a flash memory. The storage server 32 receives requests from the computation nodes 33 to 35, reads out requested training data, and transmits the requested training data to the computation nodes 33 to 35 as replies. The machine learning model trained in the second embodiment is an image recognition model, and the training data in the second embodiment is image data to which class labels have been added. For example, the storage server 32 stores data of one million images, each of which corresponds to one megabyte.

The computation nodes 33 to 35 are each a client computer or a server computer used in parallel machine learning. The computation nodes 33 to 35 train a single machine learning model in coordination with each other. Each of the computation nodes 33 to 35 has the same initial values as the parameter values of the machine learning model. Each of the computation nodes 33 to 35 reads out different training data from the storage server 32 and generates fragmentary information for updating the parameter values of the machine learning model. Each of the computation nodes 33 to 35 aggregates different fragmentary information by performing communication and updates the parameter values of the machine learning model. The computation nodes 33 to 35 consequently have the same parameter values that have been updated. The computation nodes 33 to 35 repeat the above iteration in synchronization with each other.

The storage server 32 corresponds to the storage apparatus 21 according to the first embodiment. The computation node 33 corresponds to the information processing apparatus 10 according to the first embodiment. The computation node 34 corresponds to the information processing apparatus 22 according to the first embodiment.

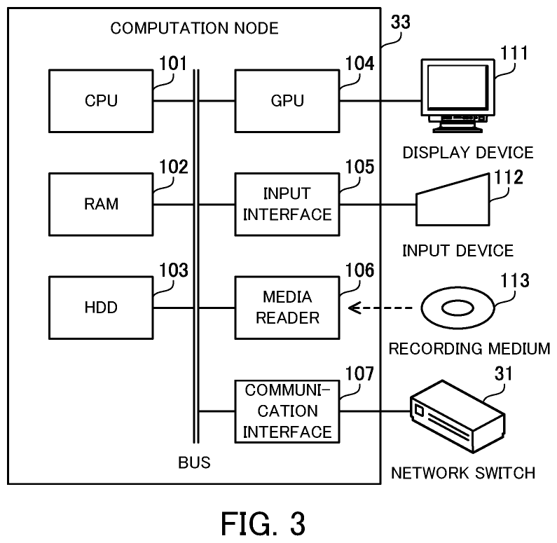

FIG. 3 is a block diagram illustrating a hardware example of a computation node.

The computation node 33 includes a CPU 101, a RAM 102, an HDD 103, a GPU 104, an input interface 105, a media reader 106, and a communication interface 107, which are connected to a bus. The CPU 101 corresponds to the processing unit 12 according to the first embodiment. The RAM 102 or the HDD 103 corresponds to the storage unit 11 according to the first embodiment. The storage server 32 and the computation nodes 34 and 35 may include the same hardware as that of the computation node 33.

The CPU 101 is a processor that executes program commands. The CPU 101 loads the program and data stored in the HDD 103 to the RAM 102 and executes the program. The computation node 33 may include a plurality of processors.

The RAM 102 is a volatile semiconductor memory that temporarily stores a program executed by the CPU 101 and data used by the CPU 101 for calculation. The computation node 33 may include a different kind of volatile memory other than a RAM.

The HDD 103 is a nonvolatile storage that stores an operating system (OS), middleware, software programs such as application software, and data. The computation node 33 may include a different kind of nonvolatile storage such as a flash memory or a solid state drive (SSD).

The GPU 104 performs image processing in coordination with the CPU 101 and outputs an image to a display device 111 connected to the computation node 33. Examples of the display device 111 include a cathode ray tube (CRT) display, a liquid crystal display (LCD), an organic electro-luminescence (EL) display, and a projector. A different kind of output device such as a printer may be connected to the computation node 33. The GPU 104 may be used as a general-purpose computing on graphics processing unit (GPGPU). The GPU 104 executes a program in response to a command from the CPU 101. The computation node 33 may include a volatile semiconductor memory other than the RAM 102 as a GPU memory.

The input interface 105 receives an input signal from an input device 112 connected to the computation node 33. Examples of the input device 112 include a mouse, a touch panel, and a keyboard. A plurality of input devices may be connected to the computation node 33.

The media reader 106 is a reading device that reads out a program and data recorded in a recording medium 113. Examples of the recording medium 113 include a magnetic disk, an optical disc, and a semiconductor memory. Examples of the magnetic disk include a flexible disk (FD) and an HDD. Examples of the optical disc include a compact disc (CD) and a digital versatile disc (DVD). The media reader 106 copies the program and data read out from the recording medium 113 to another recording medium such as the RAM 102 or the HDD 103. This program may be executed by the CPU 101.

The recording medium 113 may be a portable recording medium and may be used for distribution of the program and data. The recording medium 113 and the HDD 103 may each be referred to as a computer-readable recording medium.

The communication interface 107 is connected to the network switch 31 via a cable. The communication interface 107 communicates with the storage server 32 and the computation nodes 34 and 35 via the network switch 31. The computation node 33 may include a wireless communication interface connected to a wireless communication device such as a base station or an access point.

Next, parallel machine learning will be described.

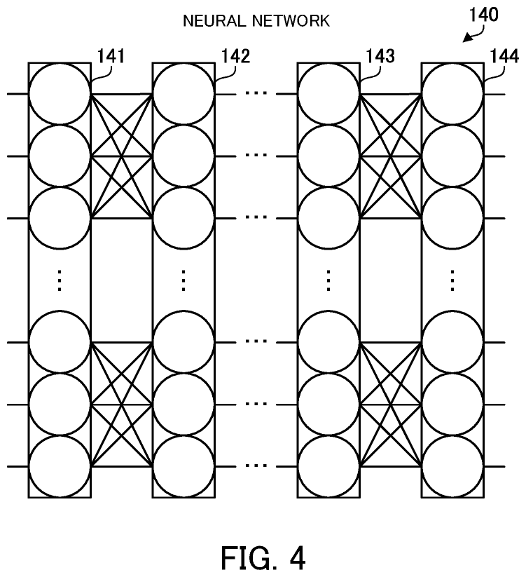

FIG. 4 illustrates a configuration example of a neural network.

A neural network 140 is an example of a machine learning model according to the second embodiment. The neural network 140 receives image data as input and estimates a class of an object included in the image data. The neural network 140 includes a plurality of layers such as layers 141 to 144. The layer 141 is an input layer that receives a tensor indicating the image data. The layer 142 is an intermediate layer immediately after the layer 141. The layer 143 is an intermediate layer immediately before the layer 144. The layer 144 is an output layer that outputs a class estimation result.

Each layer includes at least one node (normally, a plurality of nodes). There are edges between the nodes included in an individual layer other than the layer 141 and the nodes included in a layer immediately before the layer. There are edges between the nodes included in an individual layer other than the layer 144 and the nodes included in a layer immediately after the layer. Each edge has a weight as a parameter value that is optimized through machine learning. The neural network 140 may be a convolutional neural network. The convolutional neural network may include at least one convolutional layer, at least one pooling layer, and at least one fully-connected layer. The individual convolutional layer performs convolutional computation for updating the value of a certain element in the tensor by using the values of other elements around the certain element. The individual pooling layer converts a number of neighboring elements in a tensor into a single element. The value of an element after the conversion represents an average value or a maximum value of the values of elements before the conversion, for example.

The machine learning that trains the neural network 140 iteratively performs an iteration for updating the edge weights. In the machine learning, image data is inputted to the layer 141. In the machine learning, the values of the nodes included in a certain layer are multiplied by their respective edge weights, and the obtained products are supplied to the nodes included in the layer in the next stage. In the machine learning, the values supplied from the nodes included in the layer in the previous stage are added up, and the sum is converted into a value having a certain value range (for example, between 0 and 1, inclusive) by using an activation function. In the machine learning, the above computation is sequentially performed in the direction from the layer 141 to the layer 144, and a class estimation result is extracted from the layer 144. This process is sometimes referred to as a forward process.

In the machine learning, an error is calculated by comparing a class estimation result with a class label corresponding to input image data. This error is, for example, a mean squared error (MSE). In the machine learning, a forward process is performed on a certain amount of image data, and an average error is calculated. The amount of image data used in a single iteration is sometimes referred to as a batch size or a mini batch size. The mini batch size is, for example, 10 images.

In the machine learning, by propagating error information in the direction from the layer 144 to the layer 141, an error gradient with respect to an individual edge weight is calculated. An error gradient represents the amount of change in error when an edge weight is changed by a minute amount. This process is sometimes referred to as a backward process. In the machine learning, the individual edge weight is updated by using the error gradient and a learning rate. The learning rate is a hyperparameter value specified by the user. For example, in the machine learning, the error gradient is multiplied by the learning rate, and the individual edge weight is decreased by the obtained product. This updating of the edge weights is sometimes referred to as an update process.

The machine learning repeats the above iteration while changing the image data that is inputted to the neural network 140. The number of iterations is about a few dozen times to a few thousand times. In addition, in the machine learning, a plurality of iterations using different image data is performed as a set, and a set of iterations is repeated by using the same image data as that in the previous set. A set of iterations is sometimes referred to as an epoch. The number of epochs is about a few dozen times. The edge weight update method as described above is sometimes referred to as a backpropagation method. In the second embodiment, a combination of the forward process and the backward process is sometimes referred to as a “backpropagation”.

In the case of the parallel machine learning, the computation nodes 33 to 35 calculate different error gradients in parallel by using different image data on the neural network 140. The computation nodes 33 to 35 communicate with each other to aggregate the calculated error gradients. For example, the computation nodes 33 to 35 calculate an average or a sum of the calculated error gradients. The aggregation of the error gradients is sometimes referred to as a communicate process. In the parallel machine learning, the edge weights are updated by using the aggregated error gradient.

Thus, in the parallel machine learning, the communicate process is inserted between the backward process and the update process. In the second embodiment, a combination of the communicate process and the update process is sometimes referred to as a “weight sharing”.

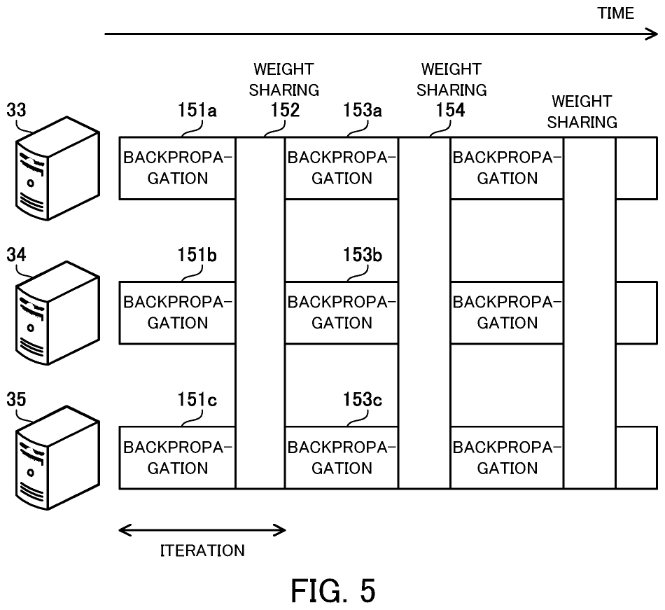

FIG. 5 illustrates an example of the parallel machine learning by the plurality of computation nodes.

The computation node 33 performs a backpropagation 151a by using image data of 10 images. The computation node 34 performs a backpropagation 151b by using image data of 10 images different from those used in the backpropagation 151a in parallel with the backpropagation 151a. The computation node 35 performs a backpropagation 151c by using image data of 10 images different from those used in the backpropagations 151a and 151b in parallel with the backpropagations 151a and 151b. Upon completion of all the backpropagations 151a to 151c, the computation nodes 33 to 35 perform a weight sharing 152. Thus, a single iteration is ended.

Next, the computation node 33 performs a backpropagation 153a by using image data of 10 images different from those used in the backpropagations 151a to 151c. The computation node 34 performs a backpropagation 153b by using image data of 10 images different from those used in the backpropagations 151a to 151c and 153a in parallel with the backpropagation 153a. The computation node 35 performs a backpropagation 153c by using image data of 10 images different from those used in the backpropagation 151a to 151c, 153a, and 153b in parallel with the backpropagations 153a and 153b. Upon completion of all the backpropagations 153a to 153c, the computation nodes 33 to 35 perform a weight sharing 154. Thus, a single iteration is ended.

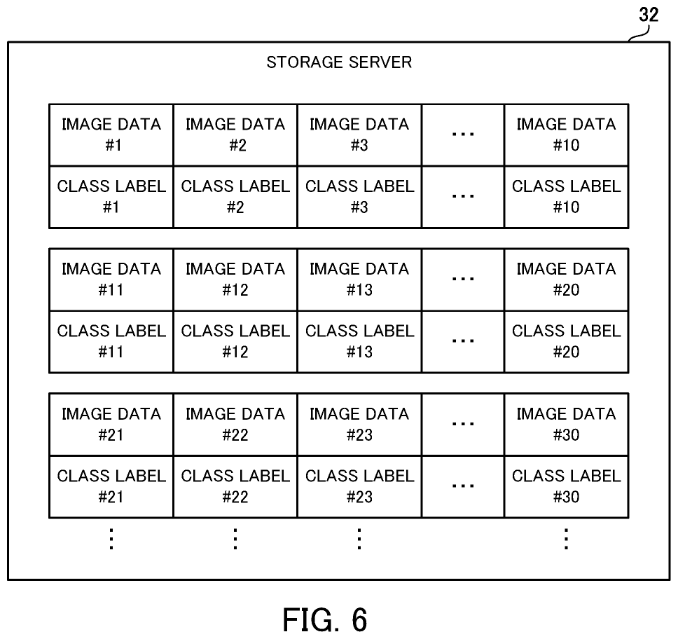

FIG. 6 illustrates an example of training data stored in the storage server.

The storage server 32 stores image data to which class labels are added. For example, the storage server 32 stores image data of a million images. The image data stored in the storage server 32 is used by the plurality of computation nodes including the computation nodes 33 to 35. For example, in a certain iteration, image data #1 to #10 is used by the computation node 33, image data #11 to #20 is used by the computation node 34, and image data #21 to #30 is used by the computation node 35.

For example, the image data used by a computation node is determined by the node number of this computation node and the current iteration number. For example, each of the computation nodes 33 to 35 calculates the image data numbers from its own node number and the current iteration number such that the calculated image data numbers do not overlap with those used by the other computation nodes and requests the storage server 32 to send the image data by specifying the calculated image data numbers.

In the parallel machine learning, the computation nodes 33 to 35 use a large amount of image data. Thus, the computation nodes 33 to 35 continuously read out image data from the storage server 32 while performing iterations. The computation nodes 33 to 35 perform the prefetch process to request the storage server 32 to send their respective image data used in a certain iteration in an iteration performed before the certain iteration. Each of the computation nodes 33 to 35 has a buffer area for storing the prefetched image data. For example, the computation nodes 33 to 35 each has a RAM including the buffer area.

In the second embodiment, the maximum value of the number of image data stored in a buffer area at the start of an iteration will be referred to as a buffer size, as needed. The buffer size is a constant multiple of the mini batch size. For example, the buffer size is equal to or twice the mini batch size. Alternatively, the buffer size may be three times, four times, or five times the mini batch size. Thus, for example, the buffer size corresponds to 10 images, 20 images, 30 images, 40 images, or 50 images. The physical storage capacity of the buffer area is, for example, 50 megabytes. When the buffer size is equal to the mini batch size, in each iteration the computation nodes 33 to 35 request the storage server 32 to send their respective image data used in the next iteration.

There is a case in which a delay could occur in the prefetching of image data from the storage server 32 to a buffer area. The prefetch delay is a temporary delay or throughput deterioration. The temporary delay is an accidental event that occurs when requests from two or more computation nodes to the storage server 32 accidentally collide with each other. The temporary delay is due to fluctuation in response time from the storage server 32 to any one of the computation nodes 33 to 35. The temporary delay occurs only in one of the plurality of computation nodes in the same iteration.

The throughput deterioration occurs when all the computation nodes request the storage server 32 to send a large amount of image data in the same iteration and the load on the storage server 32 consequently increases. The throughput deterioration extends the response time from the storage server 32 to each computation node. Thus, all the image data prefetching performed by the computation nodes is delayed.

In an information processing system in which the response time relatively largely fluctuates, if a buffer size is set to be excessively small, there is a case in which the image data used in a certain iteration has not sufficiently been stored in the buffer area at the start of the certain iteration. In this case, the start of a backpropagation in one of the computation nodes is delayed, and a latency occurs in the other computation nodes until the start of a weight sharing. In contrast, if a buffer size is set to be excessively large, the throughput deterioration could occur. In this case, the start of a backpropagation could be delayed in all the computation nodes.

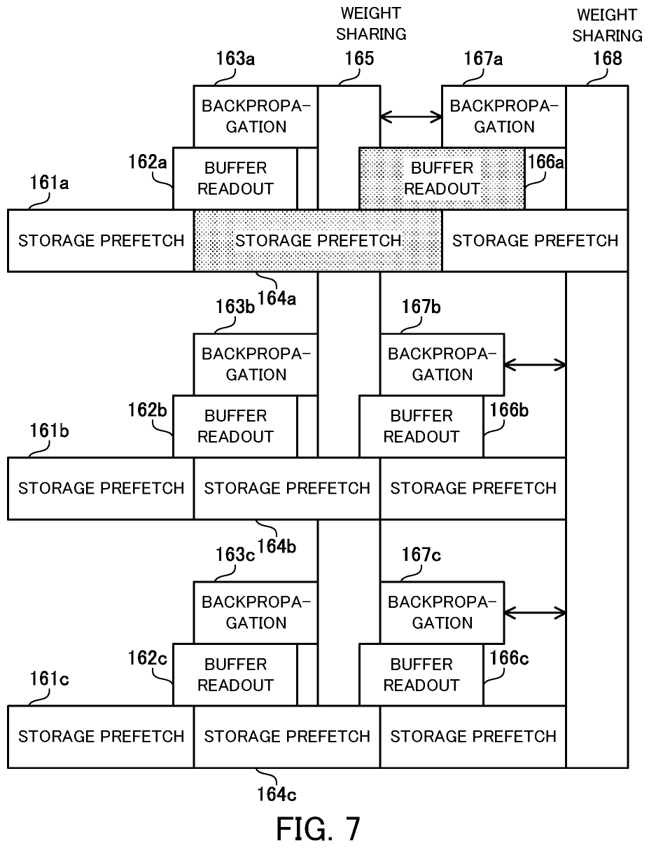

FIG. 7 illustrates an example of a temporary delay in a storage prefetch.

The computation node 33 starts a storage prefetch 161a to request the storage server 32 to send image data and to store the image data in its buffer area. The computation node 33 starts a buffer readout 162a to read out the image data of a mini batch size from its buffer area shortly before the completion of the storage prefetch 161a (for example, when the image data of 7 images out of the 10 images has been written in its buffer area). Upon completion of the storage prefetch 161a, the computation node 33 starts a backpropagation 163a to calculate the individual error gradient by using the image data read out in the buffer readout 162a.

In addition, the computation node 33 starts a storage prefetch 164a to prefetch the image data in the next iteration from the storage server 32 in parallel with the backpropagation 163a. The storage prefetch 164a is for supplying the deficiency of image data in the buffer readout 162a. The amount of image data requested is determined by subtracting the amount of image data buffered at the start of the iteration from the buffer size and adding the mini batch size to the obtained difference.

The computation node 34 starts a storage prefetch 161b in parallel with the computation node 33. The computation node 34 starts a buffer readout 162b shortly before the completion of the storage prefetch 161b. Upon completion of the storage prefetch 161b, the computation node 34 starts a backpropagation 163b and a storage prefetch 164b.

The computation node 35 starts a storage prefetch 161c in parallel with the computation nodes 33 and 34. The computation node 35 starts a buffer readout 162c shortly before the completion of the storage prefetch 161c. Upon completion of the storage prefetch 161c, the computation node 35 starts a backpropagation 163c and a storage prefetch 164c. Upon completion of the backpropagations 163a to 163c, the computation nodes 33 to 35 perform a weight sharing 165 to aggregate their error gradients and to update their weights. In this way, a single iteration is ended.

The computation node 33 starts a buffer readout 166a shortly before the completion of the weight sharing 165. However, the time needed for completing the storage prefetch 164a is extended by a temporary delay. Because the buffer size of the computation node 33 is small in this case, the mini batch size of image data has not sufficiently been stored in the buffer area at the start of the buffer readout 166a. Thus, because the buffer readout 166a needs to wait until the mini batch size of image data is sufficiently stored in the buffer area, the time needed for the buffer readout 166a is extended.

Upon completion of the storage prefetch 164a, the computation node 33 starts a backpropagation 167a and the next storage prefetch. The delay in the storage prefetch 164a has caused a latency between the weight sharing 165 and the backpropagation 167a.

The computation node 34 starts a buffer readout 166b shortly before the completion of the weight sharing 165. Upon completion of the storage prefetch 164b and the weight sharing 165, the computation node 34 starts a backpropagation 167b and the next storage prefetch. Unlike the computation node 33, no temporary delay has occurred in the storage prefetch 164b. Thus, there is no latency between the weight sharing 165 and the backpropagation 167b.

The computation node 35 starts a buffer readout 166c shortly before the completion of the weight sharing 165. Upon completion of the storage prefetch 164c and the weight sharing 165, the computation node 35 starts a backpropagation 167c and the next storage prefetch. Unlike the computation node 33, no temporary delay has occurred in the storage prefetch 164c. Thus, there is no latency between the weight sharing 165 and the backpropagation 167c.

Upon completion of the backpropagations 167a to 167c, the computation nodes 33 to 35 perform a weight sharing 168. At this point, because of the temporary delay in the computation node 33, the backpropagation 167a has not been completed at the time of the completion of the backpropagations 167b and 167c. Thus, a latency has occurred between the backpropagation 167b and the weight sharing 168 and between the backpropagation 167c and the weight sharing 168. As described above, if the buffer size is excessively small, there is a case in which the buffering may fail to cover a response delay of the storage server 32, and as a result, an unexpected latency could occur.

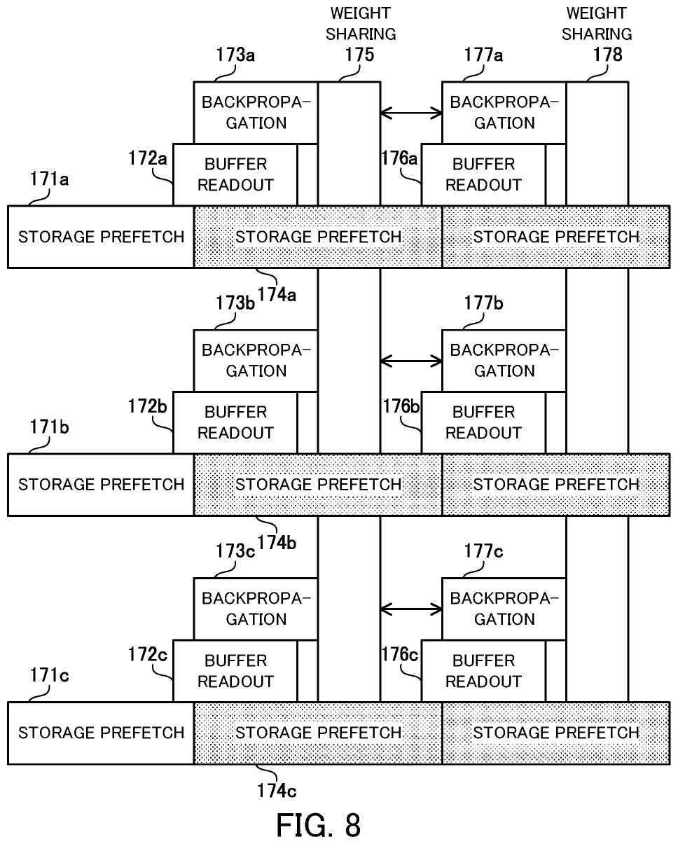

FIG. 8 illustrates an example of deterioration in the throughput of the storage server.

The computation node 33 starts a storage prefetch 171a. The computation node 34 starts a storage prefetch 171b. The computation node 35 starts a storage prefetch 171c. In these storage prefetches 171a to 171c, the computation nodes 33 to 35 request the storage server 32 to send image data of a mini batch size in order to start the first iteration promptly.

Next, the computation node 33 starts a buffer readout 172a. Upon completion of the storage prefetch 171a, the computation node 33 starts a backpropagation 173a and a storage prefetch 174a. The computation node 34 starts a buffer readout 172b. Upon completion of the storage prefetch 171b, the computation node 34 starts a backpropagation 173b and a storage prefetch 174b. The computation node 35 starts a buffer readout 172c. Upon completion of the storage prefetch 171c, the computation node 35 starts a backpropagation 173c and a storage prefetch 174c.

In this case, because the buffer sizes are large, in the storage prefetches 174a to 174c, the computation nodes 33 to 35 request the storage server 32 to send larger amounts of image data than those in the storage prefetches 171a to 171c. Because the larger amounts of image data are requested by the computation nodes 33 to 35, the throughput of the storage server 32 is deteriorated and the response time is consequently extended. Thus, the time needed for the storage prefetches 174a to 174c is extended.

Upon completion of the backpropagations 173a to 173c, the computation nodes 33 to 35 perform a weight sharing 175. However, at the time of the completion of the weight sharing 175, sufficient image data has not been stored yet in the buffer areas of the computation nodes 33 to 35.

The computation node 33 starts a buffer readout 176a shortly before the completion of the storage prefetch 174a. Upon completion of the storage prefetch 174a, the computation node 33 starts a backpropagation 177a and the next storage prefetch. The computation node 34 starts a buffer readout 176b shortly before the completion of the storage prefetch 174b. Upon completion of the storage prefetch 174b, the computation node 34 starts a backpropagation 177b and the next storage prefetch. The computation node 35 starts a buffer readout 176c shortly before the completion of the storage prefetch 174c. Upon completion of the storage prefetch 174c, the computation node 35 starts a backpropagation 177c and the next storage prefetch.

Because of the delay in the storage prefetch 174a, there is a latency between the weight sharing 175 and the backpropagation 177a. In addition, because of the delay in the storage prefetch 174b, there is a latency between the weight sharing 175 and the backpropagation 177b. In addition, because of the delay in the storage prefetch 174c, there is a latency between the weight sharing 175 and the backpropagation 177c. Upon completion of the backpropagations 177a to 177c, the computation nodes 33 to 35 perform a weight sharing 178.

As described above, when the individual buffer size is excessively large, there are cases in which the throughput of the storage server 32 is deteriorated, the prefetch process is delayed, and a latency is caused. To avoid this problem, the information processing system according to the second embodiment automatically adjusts the individual buffer size.

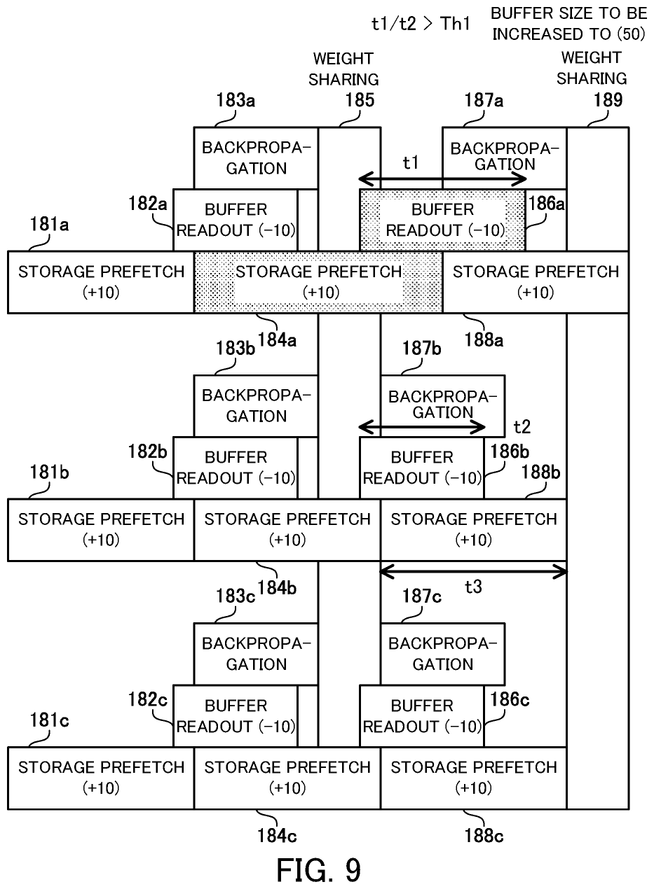

FIG. 9 illustrates the first half of an example in which the buffer sizes are changed.

This example assumes that the mini batch size corresponds to 10 images and the initial value of the buffer size corresponds to 10 images. The computation node 33 starts a storage prefetch 181a to request image data of 10 images. The computation node 34 starts a storage prefetch 181b to request image data of 10 images. The computation node 35 starts a storage prefetch 181c to request image data of 10 images. As a result, image data of 10 images is accumulated in each of the buffer areas of the computation nodes 33 to 35.

The computation node 33 starts a buffer readout 182a to read out the image data of 10 images. Next, the computation node 33 starts a backpropagation 183a and a storage prefetch 184a to request image data of 10 images. In this example, the time needed for the storage prefetch 184a is extended by the temporary delay. The computation node 34 starts a buffer readout 182b to read out image data of 10 images. Next, the computation node 34 starts a backpropagation 183b and a storage prefetch 184b to request image data of 10 images.

The computation node 35 starts a buffer readout 182c to read out image data of 10 images. Next, the computation node 35 starts a backpropagation 183c and a storage prefetch 184c to request image data of 10 images. As a result, image data of 10 images is accumulated in each of the buffer areas of the computation nodes 33 to 35. Upon completion of the backpropagations 183a to 183c, the computation nodes 33 to 35 perform a weight sharing 185. Thus, a single iteration is ended.

The computation node 33 starts a buffer readout 186a to read out image data of 10 images. Next, the computation node 33 starts a backpropagation 187a and a storage prefetch 188a to request image data of 10 images. In this example, because of the delay in the storage prefetch 184a, the time needed for the buffer readout 186a is extended. The computation node 33 measures a buffer readout time t1 needed for the buffer readout 186a. The buffer readout time is the time from when the computation node 33 starts accessing its buffer area for reading out the image data to when the computation node 33 completes reading out the image data of the mini batch size.

The computation node 34 starts a buffer readout 186b to read out image data of 10 images. Next, the computation node 34 starts a backpropagation 187b and a storage prefetch 188b to request image data of 10 images. The computation node 34 measures a buffer readout time t2 needed for the buffer readout 186b. In addition, the computation node 34 measures a storage prefetch time t3 needed for the storage prefetch 188b. The storage prefetch time is the time from when the computation node 34 requests the storage server 32 to send the image data to when the computation node 34 completes writing all the requested image data in its buffer area.

The computation node 35 starts a buffer readout 186c to read out image data of 10 images. Next, the computation node 35 starts a backpropagation 187c and a storage prefetch 188c to request image data of 10 images. Aa a result, image data of 10 images is accumulated in each of the buffer areas of the computation nodes 33 to 35. Upon completion of the backpropagations 187a to 187c, the computation nodes 33 to 35 perform a weight sharing 189. Thus, a single iteration is ended.

In this example, the computation node 33 acquires the buffer readout time t2 from the computation node 34. The computation node 33 calculates an inter-node ratio t1/t2 by dividing the buffer readout time t1 measured by the computation node 33 by the buffer readout time t2 measured by the computation node 34 and compares the obtained result with a preset threshold Th1. The threshold Th1 is a numeral value greater than 1. If the inter-node ratio t1/t2 is greater than the threshold Th1, the computation node 33 determines to increase its buffer size from the next iteration. The computation nodes 34 and 35 also perform the same determination as the computation node 33. If at least one of the computation nodes determines to increase its buffer size, all the computation nodes 33 to 35 increase their respective buffer sizes. All the computation nodes 33 to 35 consequently have the same buffer size. This example assumes that each of the buffer sizes of the computation nodes 33 to 35 is increased to a size of 50 images.

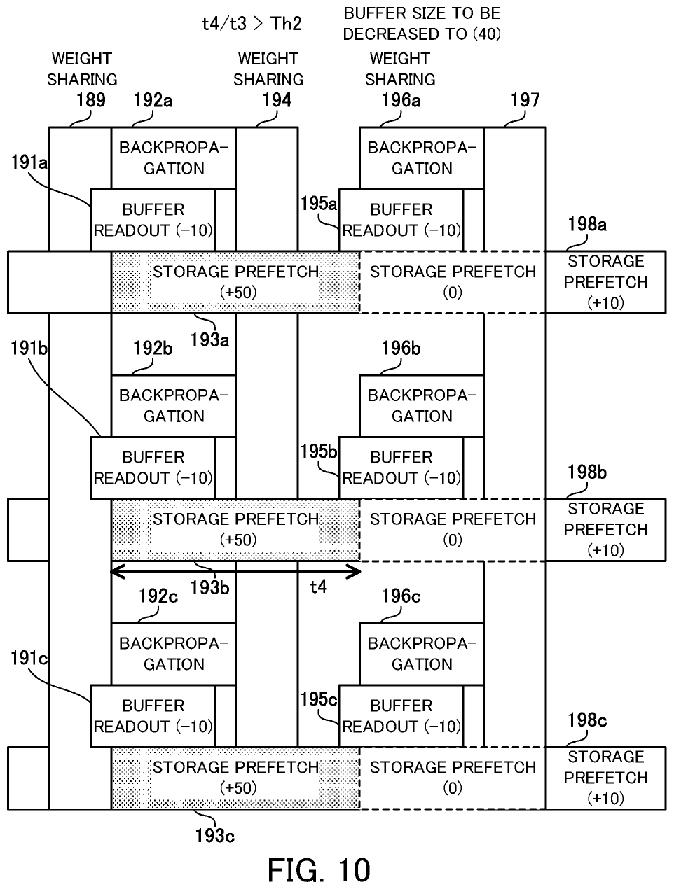

FIG. 10 illustrates the second half of an example in which the buffer sizes are changed.

The computation node 33 starts a buffer readout 191a to read out image data of 10 images. Next, the computation node 33 starts a backpropagation 192a and a storage prefetch 193a to request image data of 50 images. The computation node 34 starts a buffer readout 191b to read out image data of 10 images. Next, the computation node 34 starts a backpropagation 192b and a storage prefetch 193b to request image data of 50 images.

The computation node 35 starts a buffer readout 191c to read out image data of 10 images. Next, the computation node 35 starts a backpropagation 192c and a storage prefetch 193c to request image data of 50 images. As a result, image data of 50 images is accumulated in each of the buffer areas of the computation nodes 33 to 35. Upon completion of the backpropagations 192a to 192c, the computation nodes 33 to 35 perform a weight sharing 194. Thus, a single iteration is ended.

Because the buffer sizes are rapidly increased, in the storage prefetches 193a to 193c, the computation nodes 33 to 35 request the storage server 32 to send a large amount of image data at the same time. In this example, because the load on the storage server 32 is increased and the throughput of the storage server 32 is deteriorated, the time needed for the storage prefetches 193a to 193c is extended. The computation node 34 calculates a storage prefetch time t4 needed for the storage prefetch 193b.

In this example, the computation node 34 calculates an inter-iteration ratio t4/t3 by dividing the storage prefetch time t4 by the storage prefetch time t3 in the previous iteration and compares the inter-iteration ratio t4/t3 with a preset threshold Th2. The threshold Th2 is a numerical value greater than 1. If the inter-iteration ratio t4/t3 is greater than the threshold Th2, the computation node 34 determines to decrease its buffer size from the next iteration. The computation nodes 33 and 35 also perform the same determination as the computation node 34. This example assumes that each of the buffer sizes of the computation nodes 33 to 35 is decreased to a size of 40 images.

The computation node 33 starts a buffer readout 195a to read out image data of 10 images and starts a backpropagation 196a. In this iteration, image data corresponding to the buffer size is stored in the buffer area, without requesting the storage server 32 to send the image data. Thus, the computation node 33 does not perform a storage prefetch.

The computation node 34 starts a buffer readout 195b to read out image data of 10 images and starts a backpropagation 196b. The computation node 35 starts a buffer readout 195c to read out image data of 10 images and starts a backpropagation 196c. As a result, image data of 40 images is accumulated in each of the buffer areas of the computation nodes 33 to 35. Upon completion of the backpropagations 196a to 196c, the computation nodes 33 to 35 perform a weight sharing 197. Thus, a single iteration is ended.

In the next iteration, the computation node 33 starts a storage prefetch 198a to request image data of 10 images. The computation node 34 starts a storage prefetch 198b to request image data of 10 images. The computation node 35 starts a storage prefetch 198c to request image data of 10 images. As a result, image data of 40 images is accumulated in each of the buffer areas of the computation nodes 33 to 35.

As described above, if any one of the computation nodes 33 to 35 determines that the inter-node ratio is greater than the threshold Th1, the computation nodes 33 to 35 determine that a temporary delay that the buffering fails to cover has occurred and increase their respective buffer sizes. In contrast, if the computation nodes 33 to 35 determine that their respective inter-iteration ratios are greater than the threshold Th2, the computation nodes 33 to 35 determine that deterioration in the throughput of the storage server 32 has occurred and decrease their respective buffer sizes. As a result, the buffer sizes are appropriately adjusted to suit the system environment. The buffer size that has converged to a suitable size is a buffer size that covers the fluctuation in the response time of the storage server 32 and that is less than the capacity of the storage server 32.

The following description will be made on the total learning time of the parallel machine learning, assuming that T denotes the total learning time, N denotes the number of computation nodes, and I denotes the number of iterations. In addition, the following description assumes that x denotes the execution time per iteration without delay, x_{d} denotes an average delay time of temporary delays, x_{c} denotes an average delay time caused by deterioration in throughput, p_{d} denotes a probability of occurrence of a temporary delay, and p_{c} denotes a probability of occurrence of deterioration in throughput.

If the individual buffer size is set to an excessively small fixed value, T=I×N×(x+p_{d}×x_{d}). If the individual buffer size is set to an excessively large fixed value, T=I×N×(x+p_{c}×x_{c}). In contrast, if the individual buffer size is automatically adjusted according to the second embodiment, T=I ×N×x. The comparison between the second embodiment and the case in which the individual buffer size is set to an excessively large fixed value indicates that the second embodiment achieves an improvement rate (x+p_{c}×x_{c})/x.

Next, functions and process procedures of the computation nodes 33 to 35 will be described.

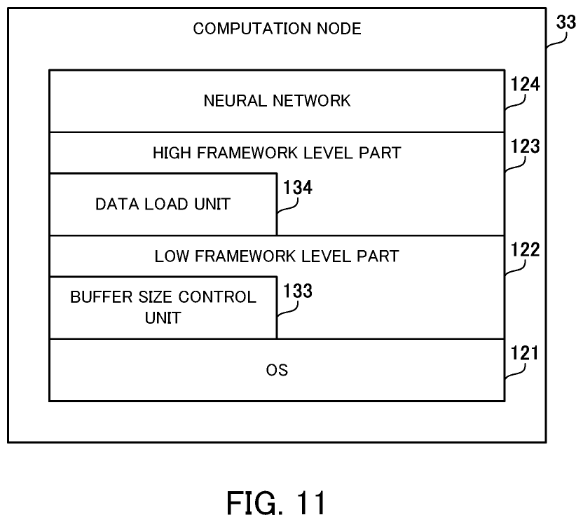

FIG. 11 is a block diagram illustrating an example of a software hierarchy of the computation node.

The computation node 33 includes an OS 121, a low framework level part 122, a high framework level part 123, and a neural network 124. The computation nodes 34 and 35 may have the same software hierarchy as that of the computation node 33.

The OS 121 manages computation resources of the computation node 33, such as the CPU 101, the RAM 102, and the GPU 104. The GPU 104 may be used for the machine learning. The low framework level part 122 is a module that performs low level control in the machine learning framework including a machine learning library program. For example, the low level control includes communicating with the other computation nodes and ensuring a buffer area. The low framework level part 122 includes a buffer size control unit 133 that automatically adjusts the buffer size in accordance with the above method.

The high framework level part 123 is a module that performs high level control in the machine learning framework. For example, the high level control includes reading out training data and updating the parameters of the machine learning model. The high framework level part 123 includes a data load unit 134 that reads out image data from the storage server 32 to the buffer area. The neural network 124 is a machine learning model including the parameter values trained by the parallel machine learning.

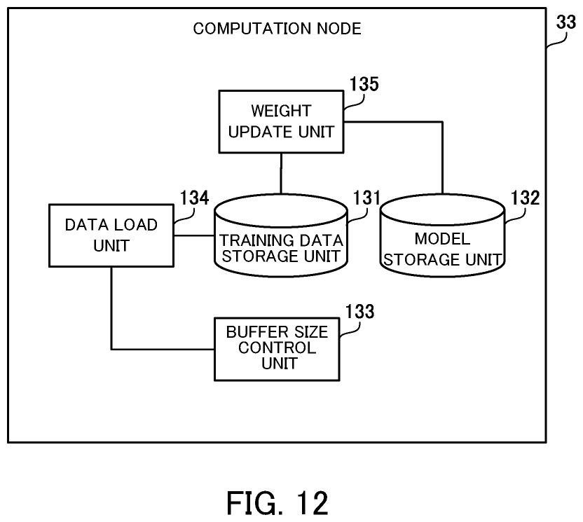

FIG. 12 is a block diagram illustrating a functional example of a computation node.

The computation node 33 includes a training data storage unit 131, a model storage unit 132, a buffer size control unit 133, a data load unit 134, and a weight update unit 135. The training data storage unit 131 and the model storage unit 132 are implemented by using, for example, the RAM 102 or the HDD 103. The buffer size control unit 133, the data load unit 134, and the weight update unit 135 are implemented by using, for example, the CPU 101 or the GPU 104 and a program.

The training data storage unit 131 includes a buffer area. The data load unit 134 writes image data in the buffer area. In addition, the weight update unit 135 reads out the image data from the buffer area. Class labels are added to the image data. The model storage unit 132 stores a neural network as a machine learning model. The neural network includes parameter values including edge weights.

The buffer size control unit 133 controls the buffer size of the buffer area. The buffer size control unit 133 measures a buffer readout time and a storage prefetch time per iteration. The buffer size control unit 133 transmits the buffer readout time of the computation node 33 to an adjacent computation node whose node number is greater than the node number of the computation node 33 by 1 and receives a buffer readout time of an adjacent computation node whose node number is less than the buffer readout time of the computation node 33 by 1.

The buffer size control unit 133 calculates an inter-node ratio from the buffer readout times and calculates an inter-iteration ratio from the storage prefetch times. The buffer size control unit 133 selects a buffer size used in the next iteration based on the inter-node ratio and the inter-iteration ratio. The buffer size control unit 133 transmits the selected buffer size to all the other computation nodes and determines a buffer size used by the plurality of computation nodes. The buffer size control unit 133 notifies the data load unit 134 of the buffer size.

The data load unit 134 calculates, per iteration, a prefetch data amount from the current image data amount stored in the training data storage unit 131, the mini batch size, and the buffer size. The data load unit 134 requests the storage server 32 to send image data corresponding to the prefetch data amount and writes the received image data in the training data storage unit 131. For the time measurement, the data load unit 134 notifies the buffer size control unit 133 of the start and the end of the individual storage prefetch. In addition, the data load unit 134 notifies the buffer size control unit 133 of the start and the end of the individual buffer readout.

The weight update unit 135 performs an iteration in the parallel machine learning. The weight update unit 135 reads out, per iteration, image data of the mini batch size from the training data storage unit 131. The buffer readout performed by the weight update unit 135 is monitored by the data load unit 134. The weight update unit 135 performs a backpropagation by using the image data read out. The weight update unit 135 communicates with the other computation nodes, detects completion of the backpropagations by all the computation nodes, and performs a weight sharing. As a result, the weight update unit 135 updates the parameter values stored in the model storage unit 132.

The buffer size control unit 133 only needs to compare its buffer readout time with the buffer readout time of one adjacent computation node. All the buffer sizes are finally set to the maximum buffer size among the plurality of computation nodes, and the buffer size is the same as that obtained when the buffer readout time is compared with the buffer readout times of all the other computation nodes. In addition, compared with the case in which the buffer readout time is compared with the buffer readout times of all the other computation nodes, the communication amount and the computation time are less.

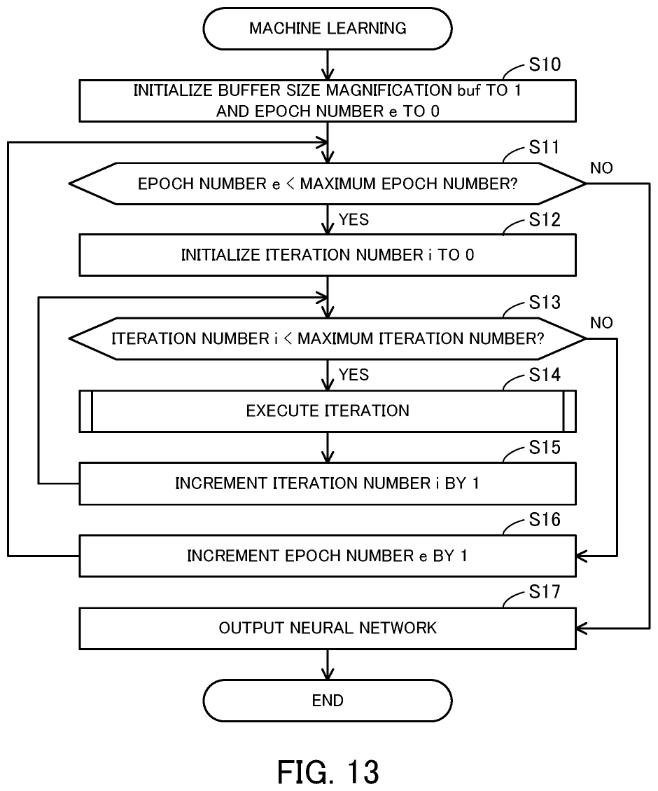

FIG. 13 is a flowchart illustrating an example of a machine learning procedure.

Hereinafter, a process of the computation node 33 will be described. The computation nodes 34 and 35 may be configured to perform the same process as that of the computation node 33.

(S10) The buffer size control unit 133 initializes a buffer size magnification buf to 1. The buffer size magnification indicates the magnification of the buffer size with respect to the mini batch size (the amount of training data used per iteration). For example, the buffer size magnification is, 1, 2, 3, 4, or 5. The weight update unit 135 initializes the epoch number to 0.

(S11) The weight update unit 135 determines whether the epoch number is less than a preset maximum epoch number. If the epoch number is less than the maximum epoch number, the process proceeds to step S12. If the epoch number has reached the maximum epoch number, the process proceeds to step S17.

(S12) The weight update unit 135 initializes an iteration number i to 0.

(S13) The weight update unit 135 determines whether the iteration number is less than a preset maximum iteration number. If the iteration number is less than the maximum iteration number, the process proceeds to step S14. If the iteration number has reached the maximum iteration number, the process proceeds to step S16.

(S14) The computation node 33 executes an iteration, which will be described below.

(S15) The weight update unit 135 increments the iteration number by 1. Next, the process returns to step S13.

(S16) The weight update unit 135 increments the epoch number by 1. Next, the process returns to step S11.

(S17) The weight update unit 135 outputs the trained neural network. The weight update unit 135 may store the neural network in a nonvolatile storage, display the neural network on the display device 111, or transmit the neural network to another information processing apparatus.

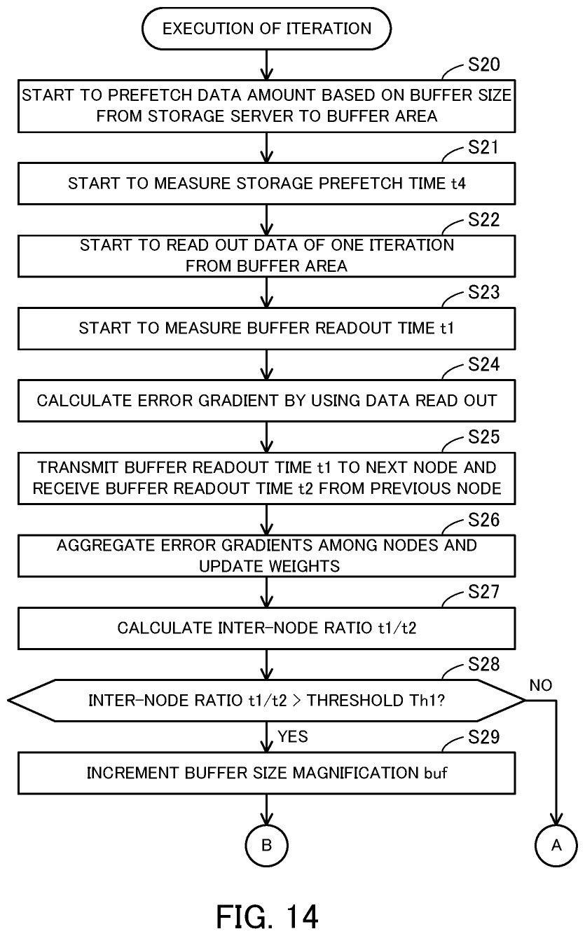

FIG. 14 is the first half of a flowchart illustrating an example of an iteration execution procedure.

(S20) The data load unit 134 starts a storage prefetch to request the storage server 32 to send image data of a data amount based on the buffer size and to read out the image data in a buffer area from the storage server 32.

(S21) The buffer size control unit 133 starts to measure the storage prefetch time t4 of the storage prefetch started in step S20.

(S22) The weight update unit 135 starts a buffer readout to read out the image data of one iteration from the buffer area, that is, the image data of a mini batch size.

(S23) The buffer size control unit 133 starts to measure the buffer readout time t1 of the reading of the buffered data started in step S22.

(S24) The weight update unit 135 performs a backpropagation to calculate the individual error gradient with respect to the individual weight, by using the image data read out by the buffer readout in step S22.

(S25) The buffer size control unit 133 transmits the buffer readout time t1 to the next computation node whose node number is greater than that of its host computation node by 1. In addition, the buffer size control unit 133 receives the buffer readout time t2 from the computation node whose node number is less than that of its host computation node by 1.

(S26) The weight update unit 135 performs a weight sharing to aggregate the error gradients among the plurality of computation nodes and to update the weights by using the aggregated error gradient.

(S27) The buffer size control unit 133 calculates the inter-node ratio t1/t2 by using the buffer readout times t1 and t2 acquired in steps S23 and S25.

(S28) The buffer size control unit 133 determines whether the inter-node ratio calculated in step S27 is greater than the preset threshold Th1. If the inter-node ratio is greater than the threshold Th1, the process proceeds to step S29. If the inter-node ratio is equal to or less than the threshold Th1, the process proceeds to step S30.

(S29) The buffer size control unit 133 increments the buffer size magnification. For example, the buffer size control unit 133 increments the buffer size magnification by 1. If the buffer size magnification is already the maximum value (for example, 5), the buffer size control unit 133 maintains the current buffer size magnification. Next, the process proceeds to step S35.

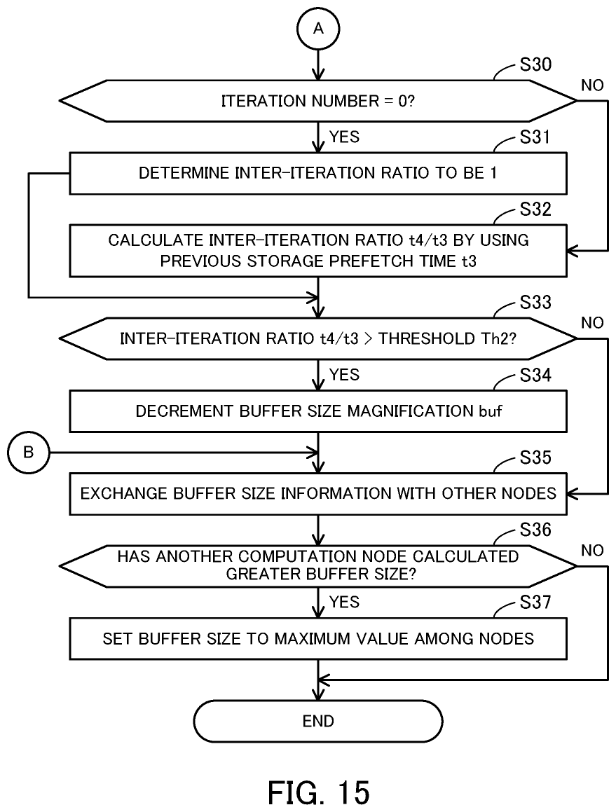

FIG. 15 is the second half of the flowchart illustrating the example of the iteration execution procedure.

(S30) The buffer size control unit 133 determines whether the iteration number is 0. If the iteration number is 0, the process proceeds to step S31. If the iteration number is equal to or greater than 1, the process proceeds to step S32.

(S31) The buffer size control unit 133 determines the inter-iteration ratio to be 1. Next, the process proceeds to step S33.

(S32) The buffer size control unit 133 calculates the inter-iteration ratio t4/t3 by using the storage prefetch time t3 measured in the previous iteration and the storage prefetch time t4 acquired in step S21. The buffer size control unit 133 stores the storage prefetch time t4 for the next iteration.

(S33) The buffer size control unit 133 determines whether the inter-iteration ratio calculated in step S31 or S32 is greater than the preset threshold Th2. The threshold Th2 may be the same as or different from the threshold Th1. If the inter-iteration ratio is greater than the threshold Th2, the process proceeds to step S34. If the inter-iteration ratio is equal to or less than the threshold Th2, the process proceeds to step S35.

(S34) The buffer size control unit 133 decrements the buffer size magnification. For example, the buffer size control unit 133 decrements the buffer size magnification by 1. If the buffer size magnification is already the minimum value (for example, 1), the buffer size control unit 133 maintains the current buffer size magnification.

(S35) The buffer size control unit 133 transmits information about the buffer size calculated by the computation node 33 to all the other computation nodes. In addition, the buffer size control unit 133 receives information about the buffer sizes calculated by the other computation nodes from the other computation nodes. The buffer size information may be about the buffer size magnification or the buffer size obtained by multiplying the buffer size magnification by the mini batch size.

(S36) The buffer size control unit 133 determines whether another computation node has calculated a buffer size that is greater than the buffer size calculated by the computation node 33. If another computation node has calculated a greater buffer size, the process proceeds to step S37. If not, the iteration is ended.

(S37) The buffer size control unit 133 determines the maximum buffer size among the buffer sizes calculated by the other computation nodes. The buffer size control unit 133 changes the buffer size of the computation node 33 to the determined maximum buffer size.

As described above, the information processing system according to the second embodiment uses the computation nodes 33 to 35, so as to calculate different error information corresponding to different training data in parallel, aggregate the error information, and update the weights of a neural network. In this way, the learning time of the machine learning for training the neural network is shortened. In addition, in the information processing system, a buffer area is set in each of the computation nodes 33 to 35, and training data is prefetched from the storage server 32 to the computation nodes 33 to 35. In this way, because the impact caused by a response delay of the storage server 32 is reduced, the iteration execution time is shortened.

In addition, in the information processing system, the individual computation node measures its buffer readout time, and different computation nodes compare their buffer readout times with each other. In the information processing system, if the inter-node ratio calculated from buffer readout times is greater than a threshold, the buffer sizes of all the computation nodes are increased. In this way, a large temporary delay that the current buffering fails to cover is detected, and the buffer sizes are adjusted to cover this temporary delay. In addition, only adjacent computation nodes whose node numbers are consecutive numbers compare their buffer readout times to calculate an inter-node ratio. In this way, the communication amount and the computation time are reduced. In addition, because the ratio is compared with the threshold, the determination is performed regardless of the scale of the individual buffer readout time.

In addition, in the information processing system, the individual computation node measures storage prefetch times and compares the storage prefetch times in two iterations with each other. In the information processing system, if a computation node determines that the inter-iteration ratio calculated from storage prefetch times is greater than a threshold, this computation node decreases its buffer size. In this way, deterioration in throughput due to overload on the storage server 32 is detected, and the individual buffer size is adjusted to improve the throughput. As a result, the individual buffer size converges to an appropriate size suitable for the system environment. In addition, because the individual buffer size is automatically adjusted, the burden on the user who would otherwise adjust the buffer sizes is reduced. In addition, because the ratio is compared with a threshold, the determination is performed regardless of the scale of the individual storage prefetch time.

In one aspect, the latency that is caused due to a training data prefetch delay in the parallel machine learning is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
measuring, in a first iteration among a plurality of iterations performed in synchronization with a different computer, each of the plurality of iterations including a training process for reading out training data from a buffer area and updating a parameter value of a machine learning model and a prefetch process for requesting a storage apparatus shared with the different computer to send training data such that the training data stored in the buffer area reaches a certain data amount, a first readout time in which the training data is read out from the buffer area; and
increasing the certain data amount used in a second iteration performed after the first iteration responsive to first delay conditions including a condition that the first readout time is greater than a second readout time measured by the different computer in the first iteration being satisfied.

2. The non-transitory computer-readable recording medium according to claim 1, wherein the first delay conditions include a condition that a ratio of the first readout time with respect to the second readout time is greater than a first threshold that is 1 or greater.

3. The non-transitory computer-readable recording medium according to claim 1, wherein the process further comprises:
measuring, in the first iteration, a first prefetch time in which training data is prefetched from the storage apparatus and stored in the buffer area; and
decreasing the certain data amount used in the second iteration responsive to second delay conditions including a condition that the first prefetch time is greater than a second prefetch time measured by the computer in a third iteration performed before the first iteration being satisfied.

4. The non-transitory computer-readable recording medium according to claim 3, wherein the second delay conditions include a condition that a ratio of the first prefetch time with respect to the second prefetch time is greater than a second threshold that is greater than 1.

5. The non-transitory computer-readable recording medium according to claim 1, the increasing of the certain data amount includes applying the certain data amount that has been increased to the different computer.

6. A parallel machine learning method comprising:
measuring, by a processor, in a first iteration among a plurality of iterations performed in synchronization with a different computer, each of the plurality of iterations including a training process for reading out training data from a buffer area and updating a parameter value of a machine learning model and a prefetch process for requesting a storage apparatus shared with the different computer to send training data such that the training data stored in the buffer area reaches a certain data amount, a first readout time in which the training data is read out from the buffer area; and
increasing, by the processor, the certain data amount used in a second iteration performed after the first iteration responsive to first delay conditions including a condition that the first readout time is greater than a second readout time measured by the different computer in the first iteration being satisfied.

7. An information processing apparatus comprising:
a memory configured to include a buffer area that stores training data received from a storage apparatus shared with a different information processing apparatus; and
a processor coupled to the memory and the processor configured to:
measure, in a first iteration among a plurality of iterations performed in synchronization with the different information processing apparatus, each of the plurality of iterations including a training process for reading out the training data from the buffer area and updating a parameter value of a machine learning model and a prefetch process for requesting the storage apparatus to send training data such that the training data stored in the buffer area reaches a certain data amount, a first readout time in which the training data is read out from the buffer area; and
increase the certain data amount used in a second iteration performed after the first iteration responsive to first delay conditions including a condition that the first readout time is greater than a second readout time measured by the different information processing apparatus in the first iteration being satisfied.
